(19) United States
(12) Patent Application Publication
(10) Pub. No.: US 2014/0052456 A1
(43) Pub. Date: Feb. 20, 2014

(54) System for Optimizing a Health Care Delivery Infrastructure by Reducing Barriers through a Comparison of an Ideal Infrastructure to a Current Infrastructure and Identifying Recommended Interventions

(71) Applicant: Prasanga Hiniduma-Lokuge, Minneapolis, MN (US)

(72) Inventor: Prasanga Hiniduma-Lokuge, Minneapolis, MN (US)

(73) Assignee: Medtronic, Inc., Minneapolis, MN (US)

(21) Appl. No.: 13/585,515

(22) Filed: Aug. 14, 2012

(51) Int. Cl. G06Q 50/22

(52) U.S. Cl. CPC G06Q 50/22
USPC 705/2

(57) ABSTRACT

Systems and methods are disclosed for evaluating geography-based health care systems and recommending infrastructure changes to the geography-based health care systems. The geography-based health care system is determined based upon data input relating to variables for which there is corresponding data in a record for a predetermined comparison health care system. Recommended infrastructure changes are based on comparison of the data of the geography-based health care system to the data of predetermined comparison health care system.

### BACKGROUND

Managing the health cam seeds of large, complex groups of people and associated infrastructures poses unique problems and barriers that are often hard to solve. These problems arise as a result of various factors which are difficult to isolate and identify because they are often multilayered, interconnected, and hard to separate. Without an efficient system and tool to determine which problems need to be addressed, in what order, and by whom; overcoming these complex sets of barriers cart seem insurmountable. One example of such a situation includes healthcare providers in underdeveloped regions of the world attempting to provide adequate patient cars while lacking many of the tools necessary to do so. The roadblocks and gaps for adequate health care vary widely, depending on the surrounding ecosystem and its many dynamic determinants such as, for example, GDP, national health care policy, economic development stage, and type of prevailing communicable or non-communicable disease.

Like most complex problems, the solution encompasses multiple approaches, variables, pathways, and parameters. Despite having the same basic elements (patients who need care, health care practitioners who provide care, and primary, secondary and tertiary level infrastructure), each health care system respires different evaluations with solutions uniquely governed by local conditions, i.e., for example, a preferred level of access to care for patients would be based on the patients' region, country, or community.

For example, geographical location is a key determinant that leads to a plurality of other equally important factors such as patient disease awareness, cultural nuances, health worker expertise and capacity, economic infrastructure, and care affordability. In these settings, it is challenging to predict the key interventions necessary to bring about improvements in healthcare deployment and delivery because of the complex and dynamic interplay of the various aforementioned factors. Faced with these challenging constraints, it is difficult for decision makers in this setting to identify the optimum pathway to provide proper care to a patient.

### SUMMARY OF THE INVENTION

This disclose describes a comprehensive, interactive tool to enable decision makers within a health care system, or any large-scale complex operation with diverse options, to identify what elements their healthcare delivery system lacks or needs in order to function at an optimal level. Further, the disclosure provides possible intervention schemes that are within the decision makers' control which, if implemented, will help improve patient outcomes by working around the system constraints. One aspect of the disclosure enables decision makers to identify the optimum level of care that can be provided using available resources. In accordance with one embodiment, the disclosure provides a process and method for use by healthcare advocates, such as Ministries of Health, medical professionals the public and private sector—which includes nongovernmental organizations (“NGOs”)—and private companies, economists and the like to evaluate their current infrastructure and recommend the appropriate interventions.

Generally, the disclosure relates to a comprehensive approach, taking into account the many variables that affect a healthcare ecosystem. The steps for optimization of patient care are determined by comparing a hypothetical ideal system to a known current system, and determining what optimal pathway system is possible based on specific constraints for a given geography, region, scenario or disease condition. Once the optimal pathway is determined, then solutions to existing barriers preventing achievement of the optimal system are recommended.

### BRIEF DESCRIPTION OF THE DRAWINGS

FIG. 1(A) is a block diagram of proposed system components. It illustrates various components of the proposed repository and computation elements.

FIG. 1(B) is a How diagram of a decision process. It demonstrates comparisons of a hypothetical ideal infrastructure to a current infrastructure and along with identified constraint and barriers, helps achieve an optimal infrastructure by recommending solutions.

FIG. 1(C) is an illustration of a pathway the decision process may take.

FIG. 2 is as illustration of an ideal health care system that can be used as a baseline.

FIG. 3 is an illustration of the model of FIG. 2 for chronic care.

FIG. 4 is a flow diagram of a query process the algorithm takes the user through.

FIG. 5 illustrates the steps required to determine the next question within a decision tree.

FIG. 6 is art illustration of a decision tree showing how each question within the query process depends on answers to previous questions.

FIG. 7 is an illustration of an interactive query to determine geographic coordinates of a targeted population.

FIG. 8 is a demonstration of the system honing in on a level selected, and asking for specific communities.

FIG. 9 is an interactive map of the district so as to pick a community of interest. When a community is picked, the algorithm reconfirms this data with the user.

FIG. 10 illustrates offering development and socioeconomic statistics relevant a specific community. It will then request info of the user about the specific population.

FIG. 11 shows a query for data about the health system in question, and the current access to care for patients in that setting. Each response to a question determines the branch of the decision tree that will be followed.

FIG. 12 shows a disease category selection process. This illustrates a decision tree used to find a disease the user is addressing.

FIG. 13 is an illustrative example of a “current system” computed from a user's responses to a query process. It illustrates the pathway a patient within that setting will follow in order to receive care.

FIG. 14 illustrates on embodiment of a differential generated when an ideal system as illustrated is FIG. 2 is compared to a current system as illustrated in FIG. 13.

FIG. 15 is the concept for computing barriers through a “flow analysis” of an optimal system and the current system.

FIG. 16 shows an example of recommended interventions deduced from solutions in a toolkit database within the repository once barriers have been identified.

FIG. 17 is a sub-algorithm for logic check and boundary condition check on “Patient Out-of-Pocket” costs based on preset boundary conditions stored in the database.

FIG. 18(A) is a diagram of a possible central processor. This would be the brain of the system and computes desired solutions based on pre-programmed algorithms.

FIG. 18(B) is a continuation of a central processor diagram. This portion demonstrates the feedback response and tool archiving once the recommended process has been computed.

FIG. 19 is an illustrative map of the harriers and solutions proposed for a health system.

FIG. 20 is an illustrative map of the barriers and solutions proposed for a health system addressing an entire disease condition.

### DETAILED DESCRIPTION OF EXEMPLARY EMBODIMENTS

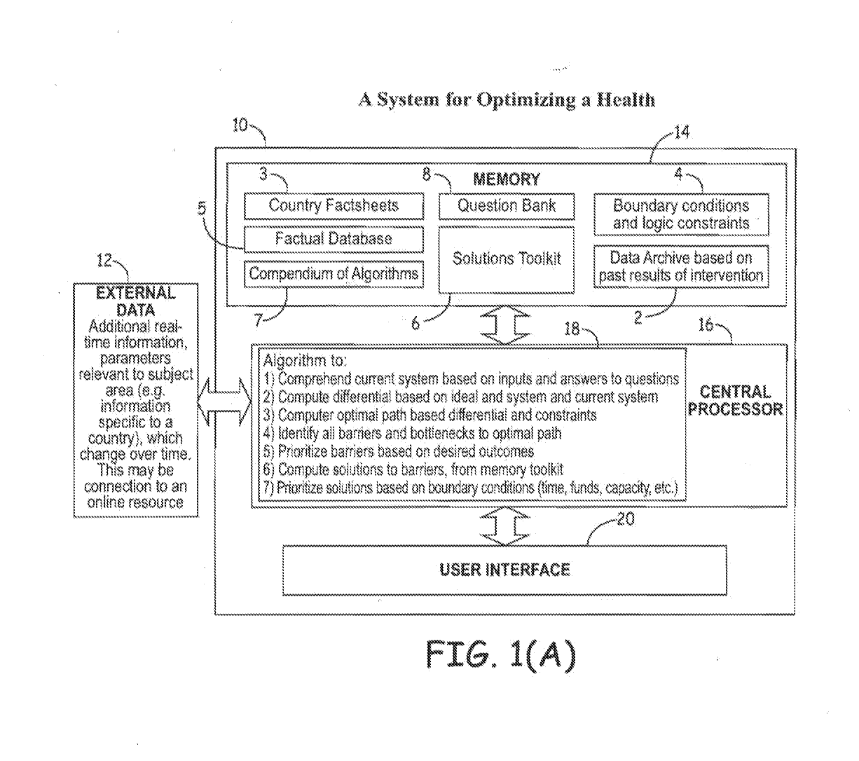

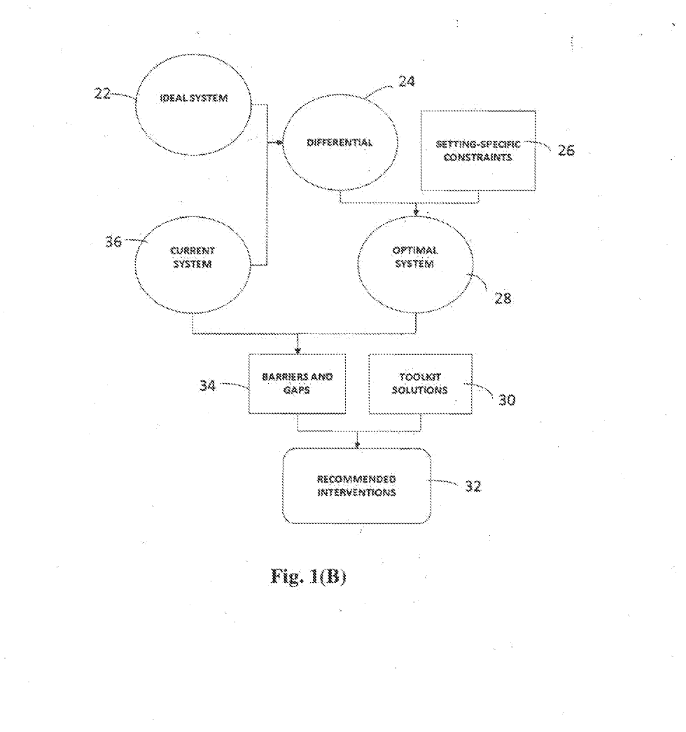

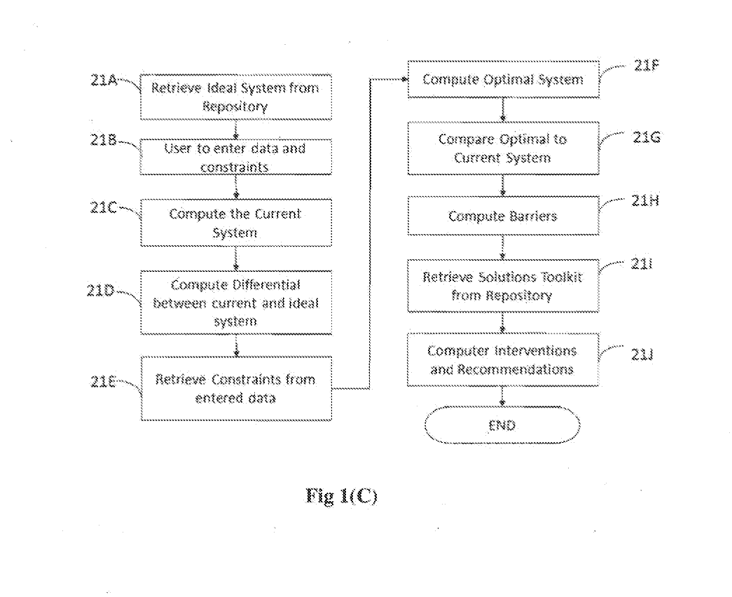

Referring to FIG. 1(A), preferred embodiments of the system component 10 include stored memory 14 to hold a repository of information used in a decision-making process. This database serves as an encyclopedia of knowledge pertaining to a list of subject areas. The extent and accuracy with which it is populated determines the efficacy of both a system and an algorithm.

The Data Archive 2 includes records of all reports that have been generated for past challenges, which can be queried, to share best practices and lessons learned. The Country Factsheets 3 can be tapped into for information pertaining to a selected country. The Factual Database 5 determines options presentable to the end user in each multiple-choice question. The Toolkit of solutions 6 may be the basis of the response repository. It is a pre-established, encyclopedic collection of information, pathways and scenarios that cover health system and health-related topics known throughout the world. It may also contain a portfolio of solutions for each possible barrier or gap that has been discovered within a health system. This portion of the database should be continually updated each time a new solution is discovered or proposed. While a less than ideal health infrastructure may be a good place to apply this embodiment, it is not limited to this scenario. Other embodiments of alternative complex infrastructures with multiple inputs and outputs may also use a disclosure. Specifically, as would be clear to a person skilled in the art, any complex system embodying multiple variables with various access points and multiple solution routes would be covered by the present disclosure.

The Compendium of Algorithms 7 contains all the algorithms and sub algorithms that make up a computation process. The list of questions within the Question Bank 8 enables the computer to induce the necessary responses from the user. These are used to compute the various segments of the larger system that lead to the optimal path. External data 12 component is used to provide updated, real-time information and serves as a link to external information.

A Central Processor 16 computes desired solutions based on pre-programmed algorithms 18 to arrive at the possible solutions based on pre-programmed algorithm. User interface 20 enables the computer to interact with the user and provides instructions and guidance for the user throughout the interactive steps. In short, interface 20 is the direct interface between the overall system and the end user, delivering questions and solutions to the end user. Specifically, central processor 16 communicates with user interface 20 to pose a decision tree format of questions to the user, with each successive question dependent on the previous answer.

Referring to FIG. 1(B) captures a conceptual framework for how a system computes interventions. Referring to FIG. 1(C) shows the flow process. First, an information repository located in the stored memory 14 of FIG. 1(A) is retrieved. A repository contains, among other things, elements of an “ideal system” 21A where currently available medical and logistical solutions are readily accessible. In this regard, stored memory 14 contains a baseline to which all other scenarios will be compared. It is updated as new information for any healthcare system pertaining to a region or geography becomes available, thus forming one of the tools for evaluating a given condition.

Next, the program queries an end user 21B to input details of the user's current scenario, through the User Interface 20 as detailed in FIG. 1(A). To do so in an intelligent and interactive manner, the query utilizes an established repository to complete the analysis. Each answer from the end user determines the next question, in a decision tree format. This populates the “current system” 21C for the analysis. Once the current system has been captured, the program then calculates the “differential” 21D between the current system 21C and the ideal system 21A. The algorithm also consults external data 12, such as an online real-time resource, for context-specific updates to this information. The differential 21D is then fed into an equation that factors in the limitations, capacities, constraints and boundary conditions that are nonnegotiable in that setting (retrieved per end user input), referred to as setting-specific constraints 21F, such as funding, patient affordability of care, or infrastructure limitations. The result of this calculation is an “optimal system” 21F. This is a recommended path for this particular health system or infrastructure given the context. As such, the optimal path for one community or village will most likely be different from the path for a neighboring village.

Having calculated an optimal system 21F, the system will then identify and prioritize all the barriers and gaps 21H that prevent translation of the current system to the optimal system. The algorithm then taps into a repository on the stored memory to consult a Solutions Toolkit 21I, which consists of multiple solutions for specific barriers within the health system, and matches appropriate interventions and solutions to each of the barriers in this particular setting. Based on the identified key barriers, the system then recommends interventions 21J so the end user knows what actions need to be taken.

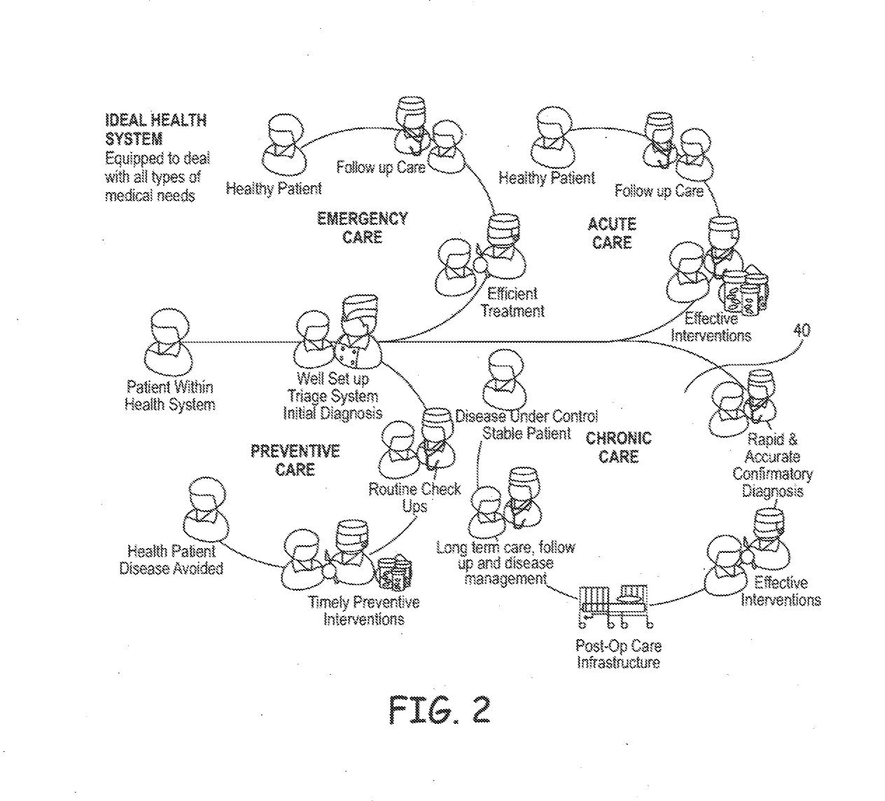

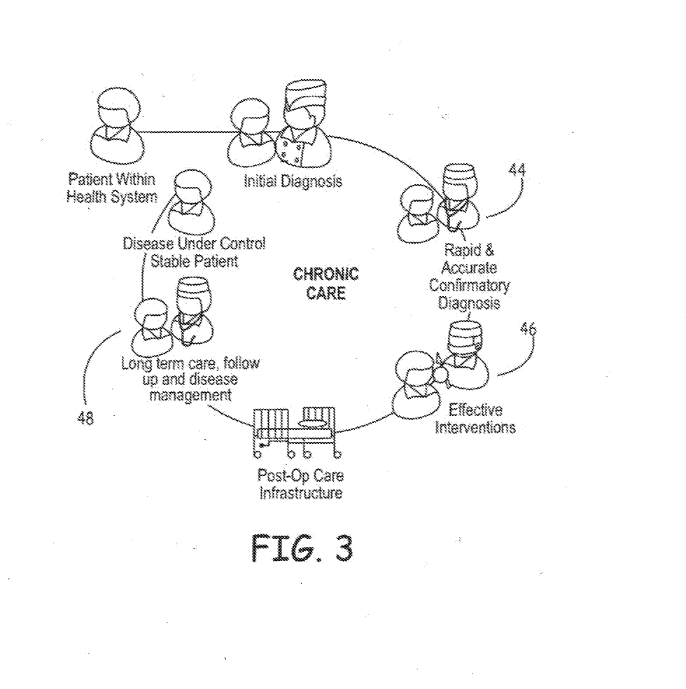

Referring to FIG. 2, an ideal system takes into account every knows necessary step required for a patient to receive a continuum of care for their condition, whatever it may be. This ideal system is equipped to handle all conditions (acute, emergency, preventive, endemic and chronic care) and care needs. The specific component of chronic care 40 is analyzed in detail in FIG. 3 below.

Referring to FIG. 3, as an illustration of the ideal system for chronic care. In this example for a patient seeking care for diabetes, an ideal system ensures that, a patient requiring care can: access the nearest health facility within ten minutes, be seen by a medical professional within ten minutes of entering the premises, receive a quick initial diagnosis (following rapid diagnostics testing and patient assessment), receive a referral to a specialist for further assessment and will receive a quick confirmatory diagnosis.

Once diagnosed, an ideal system will ensure that the patient receives effective intervention and treatment such as: a Continuous Glucose Monitor and insulin injections if the patient has just been diagnosed with Type I or progressed Type II Diabetes, drug therapy if the patient has Type II and their diabetes has not progressed too far (e.g. HbAlC levels of less than 7), amputation or surgical treatment if the condition has progressed too far, or emergency care if the patient is at risk of a diabetic coma.

A patient will also recover quickly in post-operative care, if needed, and be followed up routinely to monitor the chronic disease in the long term (includes drug prescription renewal, device monitoring, etc). Furthermore, the patient will be taught to control their disease to prevent progression or deterioration.

Each step in this process requires many elements to be in sync and functioning well for the whole system to work flawlessly. All steps first require that the patient knows enough to notice signs and symptoms of a disease so as to demand and access care in the first place. Several moving parts need to work well for each step in in this ideal system to work well. In order for rapid and accurate confirmatory diagnosis by a specialist 44, there needs to he several criteria met in order to proceed. These criteria include successful referral to a specialist, by a health provider at a primary care level, follow-up to ensure the patient follows through with their appointment, the specialist needs to be well-trained, and full access to all the devices, infrastructure, and diagnostics needed to make a sound, accurate diagnosis.

For effective intervention 46, specific criteria includes that the patient should be diagnosed accurately and in a timely manner, the patient should be followed by the system from the time they are diagnosed, and the health provider should be well trained, the supply chain of drugs and devices should be functioning well so as to ensure the required interventions are available when and where needed.

If it is a surgical intervention, the health system should ensure effective in-patient care. Pre and post-operative care is critical, and the health provider should know to follow up with the patient to ensure treatment is effective.

For proper long term care, follow up-and disease management 48, such factors include education of importance of long term monitoring, healthcare professionals well-trained, medical innovations that provide remote care to patients who are immobile, a patient should have easy access to the health provider team, etc.

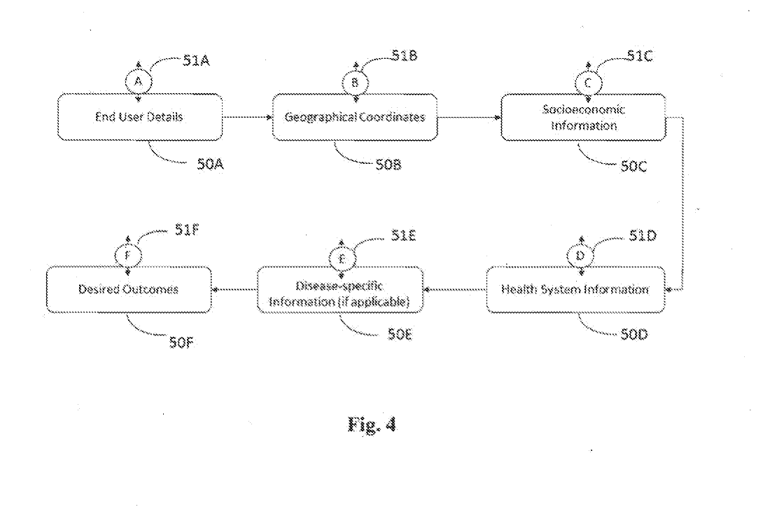

A current system 36 FIG. 1(B), which is a scenario of interest, is determined through the user query process. A key determinant of a functioning health care system is whether or not a patient receives the care that they require. As such, to determine a current system within a geographic setting, the computer places the patient at the center of its query process, shown in FIG. 4.

Further referring to FIG. 4 the query process that takes place in order is represented to provide additional details of the current system. All questions of the query process are designed in order to ascertain whether a patient is able to receive a continuum of care for his or her ailment. The algorithm takes the user through a detailed, interactive series of questions stored in a decision-tree format, wherein the response to each question determines the successive branch of the decision tree that will be followed. The End User Details 50A determine information about the user and the end purpose of the exercise (planning, implementing, policy, etc). Geographical Coordinates 50B determine location of the community, Socioeconomic Information 50C determines affordability of care by the average patient in the community. Disease-specific information 50E determines which aspect of a specific disease is of interest to the user, if at all. The Desired Outcomes 50F determine goals and desired outcomes from the end user. The Health System information 50D determines details of the current system and is the most critical part of the query process. It contains three sub categories of Infrastructure, Health Provider Information and Patient Plow through the system. Each sub category helps determine one aspect of the full picture of the health system.

An Infrastructure sub category determines infrastructure within a current setting (basic unit of health facility, referral pathways, health facility distribution within the community, logistics involved in accessing these facilities, resources for diagnosis, treatment, management of disease, availability of drugs, devices, other interventions, etc).

A Health Provider Information sub category determines details of healthcare providers (how many, educational level, training-available, remuneration of health workers, recruitment, reskilling, retention, etc), whereas the Patient flow through the system sub category determines details of how patients navigate the health system (do they know about signs and symptoms of disease, are they lost to follow up, where is their preferred first point of contact with the health system, etc.

One aspect of the invention enables an end user to enter data such that the entered information could be used to analyze and identify barriers, which need to be overcome. To begin solving the particular situation, the system takes the user through an interactive query to determine the necessary aspects for it to compare.

In order to function properly, retrieval of information from the repository 51A-51F occurs continuously throughout the query process. The type of information retrieved varies at each point during the process, and indicates the diverse categories of information stored in the repository. Important among the types of information retrieved, is the series of questions which are stored in a decision-tree format within the Question Bank and the Compendium of Algorithms that enable each step of the process. 51D indicates information is retrieved during the Health System Information part of the query process: Information retrieved at this stage helps determine the current system of interest. A CPU pulls this information from various components of a repository 14 in FIG. 1(A). At this stage, this information includes: the Question Bank which contains a series of questions to determine details of the health system, a Factual Database which determines the options that are presented to the end user in each multiple-choice question. This contains information such as the basic units of health within a country. For example, in India, the basic unit is a sub-center in most communities, it also contains information about the healthcare providers in this setting. In a sub-center, the highest level of education is a high school diploma. As such, if a user indicates they are working in a village in India, the Factual Database will ensure that the option of “BS and higher” is not offered as an option for “educational level within a sub-center.”It will also indicate that the highest level of training in a Community Health Center is a “MBBS” as this is the first level of medical education in India. At a tertiary level, it will indicate that MD is the highest level of training.

Country Fact Sheets can he tapped into for information pertaining to the country that is selected. These provide additional information on possible countries on the map. In this category, these Fact Sheets will complement information stored in the Factual Databases. A Fact Sheet, for India, will state that the State of Delhi has four major tertiary level private hospitals.

Boundary and Logic Checks verify information that is provided.

The Compendium of Algorithms may contain instructions for various types of data processing. During this stage, each response by the user is processed to determine the options provided in the next question of the branch.

The algorithms used at this stage determine the “current system” of the geography. This is an important step in the process. Algorithms can therefore compute and make conclusions where necessary when it is clear that a patient will be lost to follow up or that a patient is too far away from the nearest health facility. Sub-algorithms enable each of these deductions to be made.

The External Database contains real-time updated information from an online source. This is able to contain recent developments within a country such as “Vietnamese government has mandated Universal Healthcare for all children below the age of 5”. The information retrieved at each stage helps describe the health system.

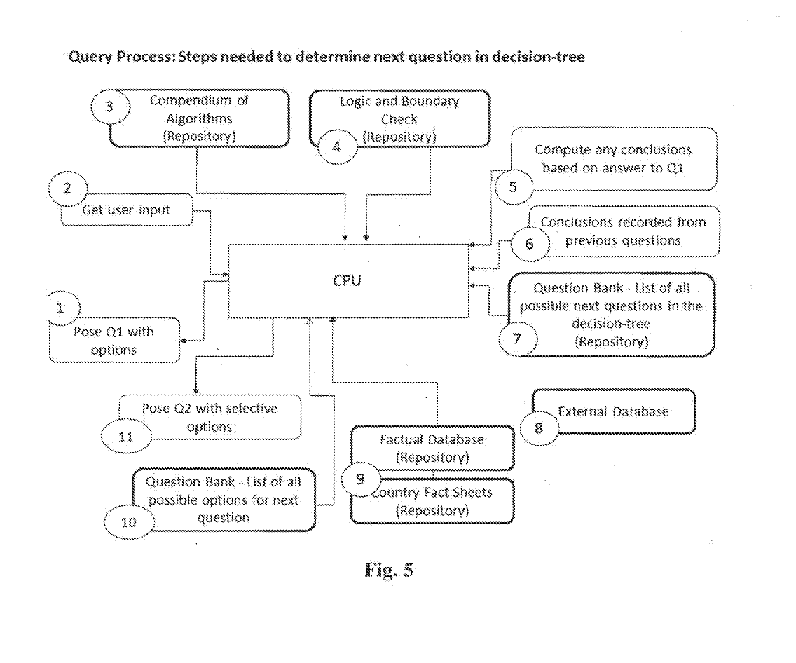

Referring to FIG. 5, which illustrates the various steps 1 through 11, that occur when a question is answered, and the next question needs to be determined. The next question in the series is dependent on the user's input, the external database and the factual database. Any conclusions that have been computed and stored per responses to previous questions are also taken into account. Once the next question is determined, the various multiple choice options are also computed based on the same determinants.

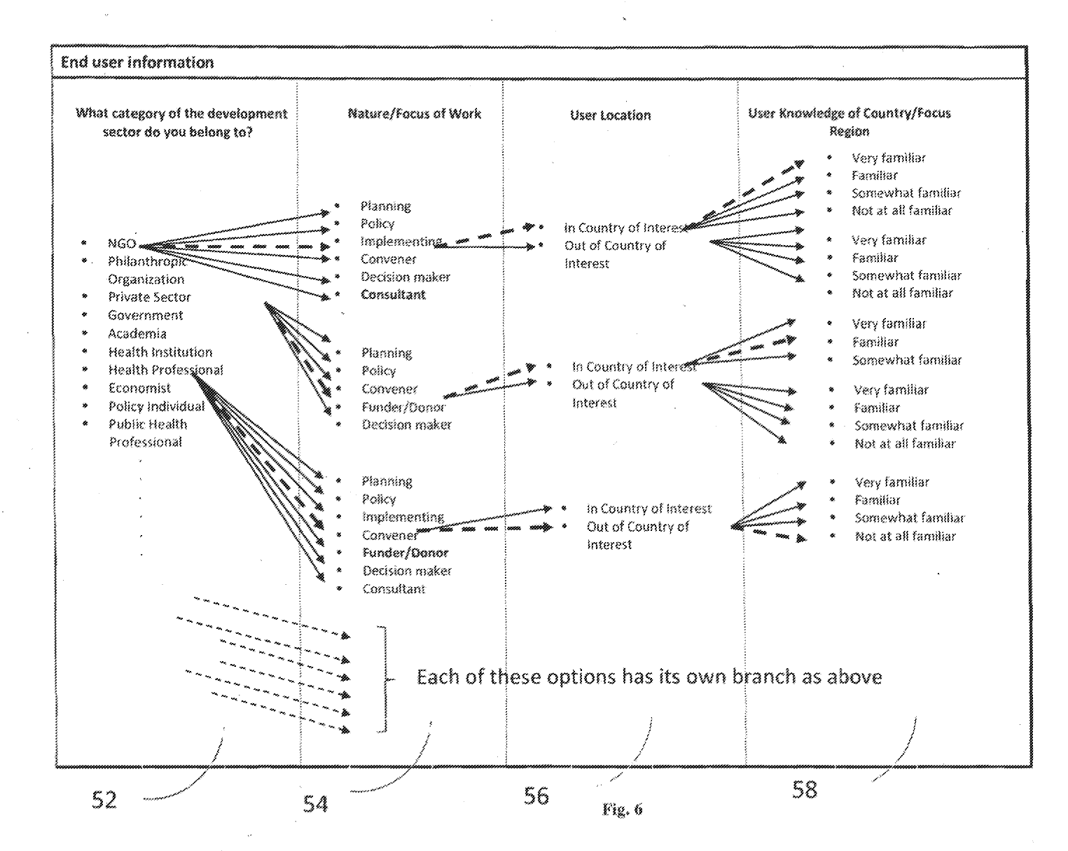

Referring to FIG. 6, as an illustration of a series of questions to gather and compile information about the end user. It begins with the category that the end user belongs to within the development sector 52—nonprofit, private sector, government, etc. Depending on the responses to this question, the “focus of work” 54 options are presented. Based on the user's response to the category segment, the options will change. For example, an NGO is not offered the option of “Funder,” while a philanthropic organization is not offered an option to “implement”. Similarly, if the user resides within the country, he or she is not offered the option “not at all familiar”. The answer to this question will determine the whole series of questions which follow. If the user is not well-versed in the target location 58, the algorithm will get whatever information it can, and then substitute its own stored information as needed.

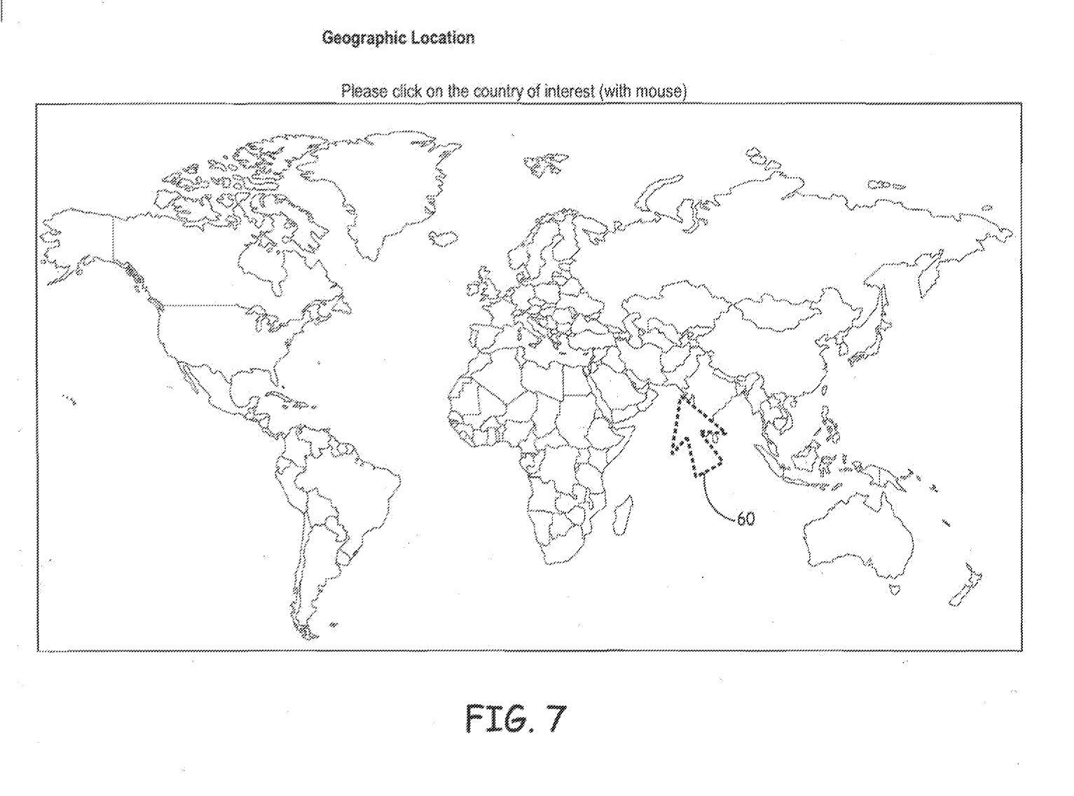

The next step is to determine the geographic coordinates of the targeted population. The end user information segment is followed by a query to determine the geographic coordinates 60 of the targeted population. FIGS. 7 through 13 are an overview of the interactive portion of the algorithm. As shown in FIG. 7, the user cars choose his or her country by selecting from a world map 60.

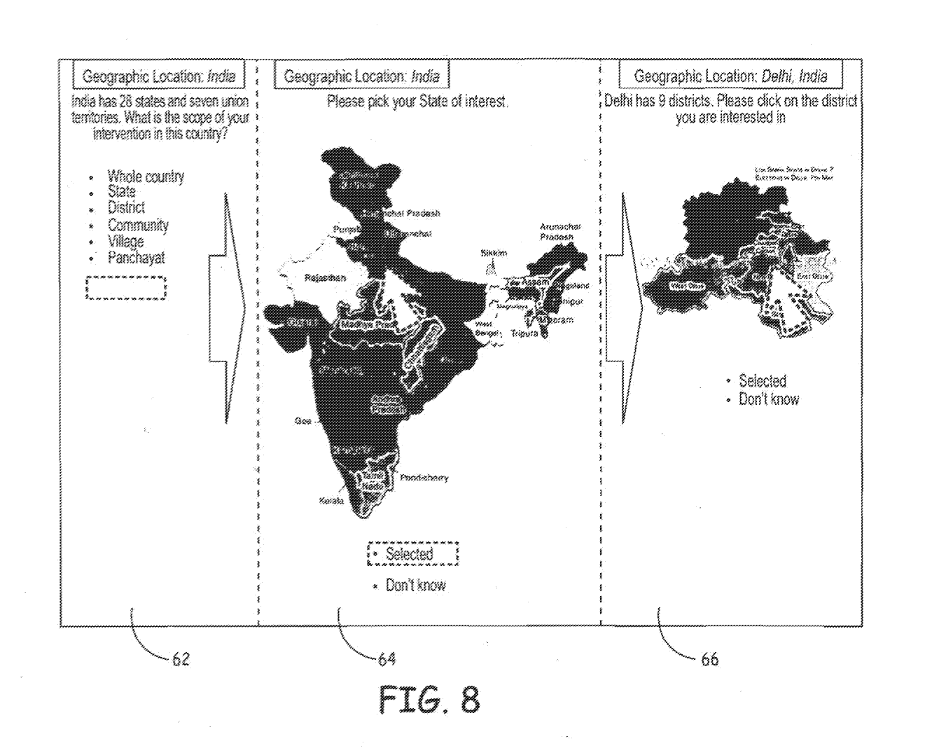

After the country is verified and selected, the query process determines the scope of the intervention—if it is country level, state level and so forth, as shown in FIG. 8. The options presented to the user will depend on the country chosen. For example, in FIG. 8, since the user picked India, he or she is offered options specific to India such as panchayat 62. This would not be an option if the user had picked Sri Lanka, for example. In that case, the choices would be limited to the village level. Once the scope is selected, the user is asked questions to hone in on the geographic level selected 64. In this situation, the algorithm will continue to query the user until the name of the community is determined. In the figure, Delhi is picked as the state 64.

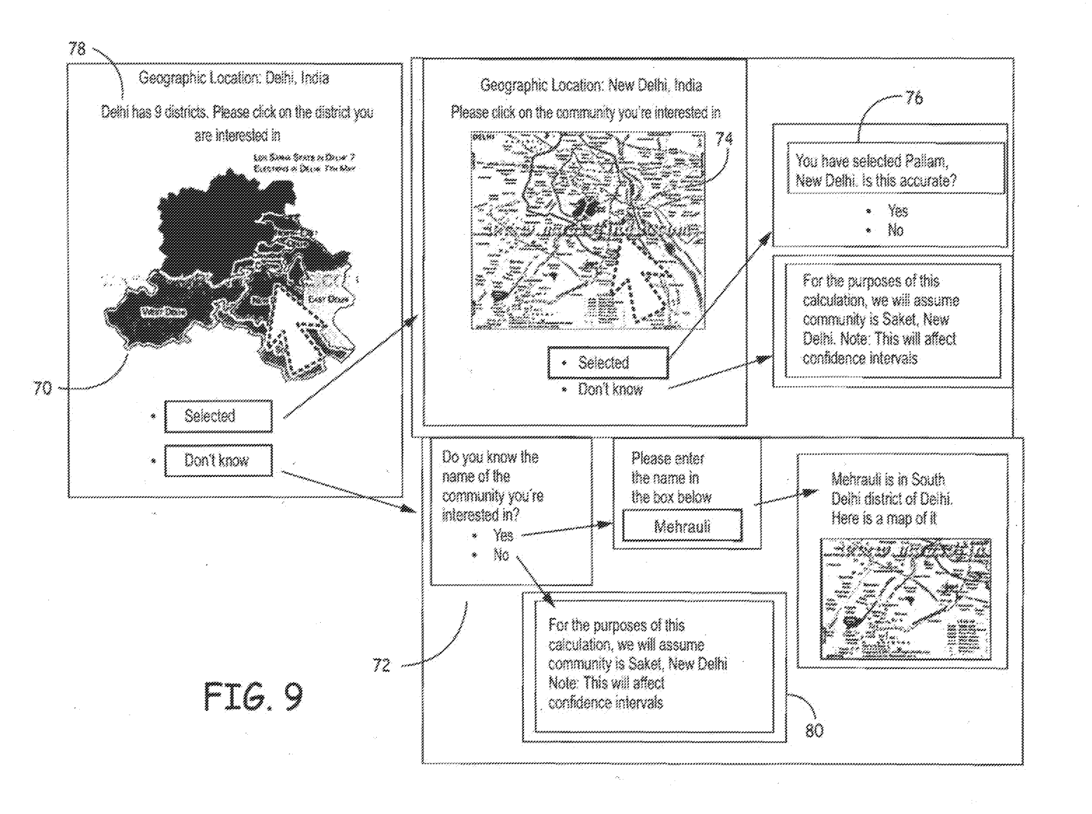

The next level down, shown in FIG. 9, the user is offered all the districts within Delhi 70 that are available. The user then has to pick one of the nine districts 70 in order to get to the community level. The information about the nine districts 78 is retrieved from the Country Factsheet (YY) in FIG. 1 (A) in the repository: If the user selects the district, in this case, New Delhi, he or she is given an interactive map of the district 74 so as to pick the community of interest. When the community is picked, the algorithm reconfirms this data with the user. If the user does not know the district, he or she is asked if they have a community name 72, if they do, they are asked to enter this. If not, the algorithm will pick a community and district that is within the State selected 80, and that it has data for. Of course, in this scenario, the results will be approximate, and the confidence intervals for the results will not be very high. The selection at this stage is not limited to political or cultural boundaries.

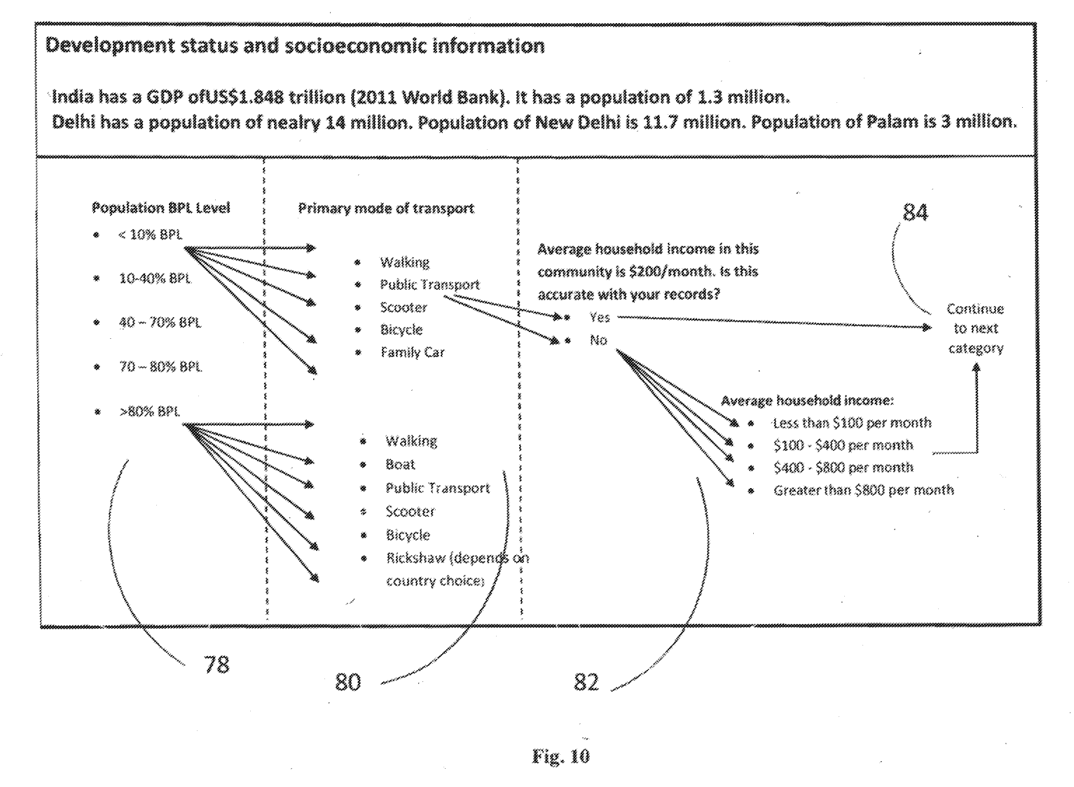

Following this data, gathering of the population of interest, the algorithm goes on to determine the socio-economic status of the population within this setting as shown in FIG. 10. It will present some data based on the information it has already gathered. For example, in this case, since the community that has been picked is Palam in New Delhi, India, it will offer statistics relevant to these places from the Country Factsheets. It will then request info of the user about the specific population 78. These questions will be based on whether the User answered “somewhat familiar” or higher in the first set of queries about user information 58 in FIG. 6. If the user answered “not familiar at all,” these questions will not be asked. The transport information 80 and income level 82 are used later when determining what solutions are viable to the patient. All the questions determine patients' ability to afford care.

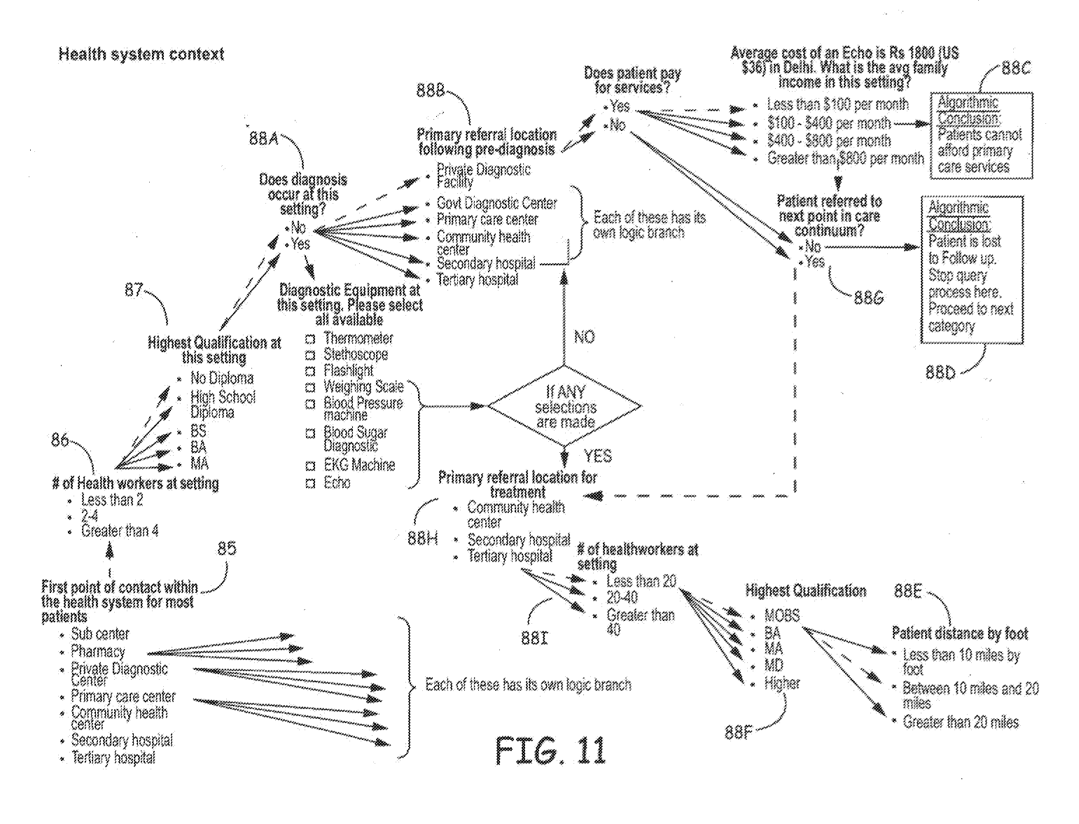

Referring to FIG. 11, the health system context and the current access to care for patients in that setting is requested. This is used to solve what resources may be available to the user. Should the user not have this information, the algorithm can retrieve from its database what information it has. This demonstrates the need for this information to be as updated as possible.

An algorithm will then query for data about the health system in question, and the current access to care for patients in that setting. Each response to a question determines the branch of the decision tree that will be followed, and will help “paint a picture” of the care delivery capacity of that setting.

Referring to FIG. 11, a summary of the key components of the query process at this, stage is presented. The first question in the series asks about the first point of care delivery within the targeted location. In this scenario, it is the sub center 85—which is expected, as this is the most common first point of delivery in India. The following question then presents an option for the number of health workers at this sub center. In this decision tree, the user has selected a sub center, which has less than 2 workers 86, who have high school diplomas 87. (Additional questions could include: the number of patients served by the sub center, and the distance the patient travels by foot to get to the sub center). The sub center serves less than 2000 patients and these patients travel less than 3 miles to get to the center. This indicates to the computer “there may be more than one sub center serving the whole community. This is also within the boundary conditions stored within the repository”.

Each response to a question determines the branch of the decision tree that will be followed. In this scenario, since the user responds that the first point of care delivery is a sub center 85, the following question presents an option for the number of health workers at this sub center, which is much lower than the number of health workers had the user selected a tertiary hospital for example.

The qualification of healthcare providers also varies with location. At a sub center, the algorithm knows not to expect a highly qualified physician and to serve at this level. Based on the data already stored in the repository, it offers options that go as low as “no diploma” 87 for workers at this setting. The tertiary hospital branch 88F however, offers options of MD since doctors are found at this level of the system in India. Note also the various qualifications provided. The first level of medical degree offered in India is the M.B.B.S which is different compared to a country such as the US where the first level of medical qualification is an M.D. This is information that the algorithm can mine from its repository or stored memory.

Similarly, the distance walked by foot by a patient who visits a sub center is much less than the distance walked by a patient going to a tertiary hospital 88E. This is because every village has at least one sub center serving about five thousand people per the information retrieved from the Country Factsheets.

In this example, a user has selected a sub center, which has less than two workers, who have high school diplomas. The sub center serves less than two thousand patients and these patients travel less than three miles to get to the center. This indicates to a computer, that there may be more than one sub center serving the whole community. This is also within boundary conditions 4 in FIG. 1(A) stored within a repository. Once care provider details have been determined, an algorithm queries the extent of care delivery at this setting. It questions if diagnosis occurs at the sub center level 88A. If not, it offers a variety of options for referral 88B. In this scenario in India, the repository indicates that Delhi also has “Private Diagnostic Facility” as an option. Once a referral location is selected, an algorithm goes onto determine if patients can afford these services 88C. The comments in boxes indicate conclusions by the software 88C and 88D, based on information provided. For instance, if an average echo costs $36 and the user indicates that average income in less than $100 per month, this level of healthcare is not affordable to the average person in this community. These conclusions are stored within the repository and dictate future questions and options.

Once afford ability of care at the primary care setting is established, the software goes onto determine the extent of the continuum of care in this setting. In this scenario, when the patient is referred to a private diagnostic facility, he or she is referred to the next point in the continuum 88G. If this were not the case, the software compotes that “there is an increased probability of the patient being lost from the care continuum”. In this exemplary situation, the patient is referred to the tertiary hospital for care regardless of symptoms or diagnosis 88H. This leads the software to conclude “the Community Health Center and secondary hospital are not used as much, and the tertiary hospital may be seeing a lot more traffic than it can handle.”

An algorithm then proceeds to query the user about the tertiary hospital. Note the difference in the selection options between the tertiary hospital 88E, 88F, 88I and the sub center 84, 86. The number of health workers is significantly higher, and the caliber of these health workers is also higher.

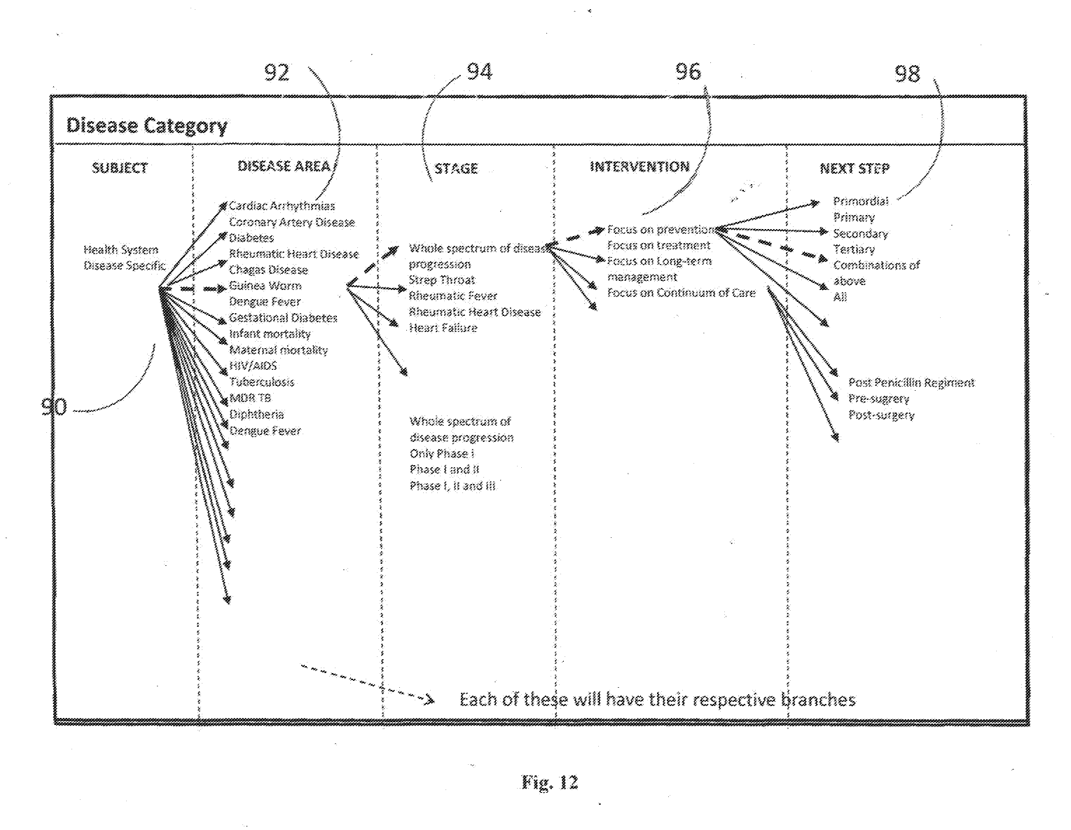

Referring to FIG. 12, illustrates an algorithm, offering an intelligently determined set of options for the diseases to be addressed. This is based on geographical information and diseases that are prevalent in that country. In this example, since India eradicated polio in early 2012, it will not offer polio as an option in the listing 92. Furthermore, for each disease that is selected, it offers the respective disease progression and interventional options 94. In this ease, rheumatic heart disease (“RHD”), progresses from strep throat to rheumatic fever to RHD to heart failure. If on the other hand, maternal mortality were selected, it would offer the choices of prenatal, perinatal and post natal. If cardiac arrhythmias were selected, it would offer a second subcategory to select from: bradycardias, tachycardias, etc.

This system is initiated by selecting a disease specific option under subject 90. Tracking, for example, a subject selection relating to RHD, under disease area 92, the user could advance to the next stage 94. Stage 94 provides with the progression of RHD. Again, assuming the user selects the whole spectrum of disease progression, the next move is to determine interventions under 96. Assuming a selection of focus on prevention, the user may advance to the next step 98. As discussed below, once the stage of RHD is determined, the proper care is to address the disease condition.

Following all this info, an algorithm queries what the user's desired outcomes are. In this situation, given that the focus is on RHD within this health system, the following desired outcomes are proposed: decrease prevalence of disease, decrease mortality from disease, increase early diagnosis of disease, and increase patients accessing care for this disease.

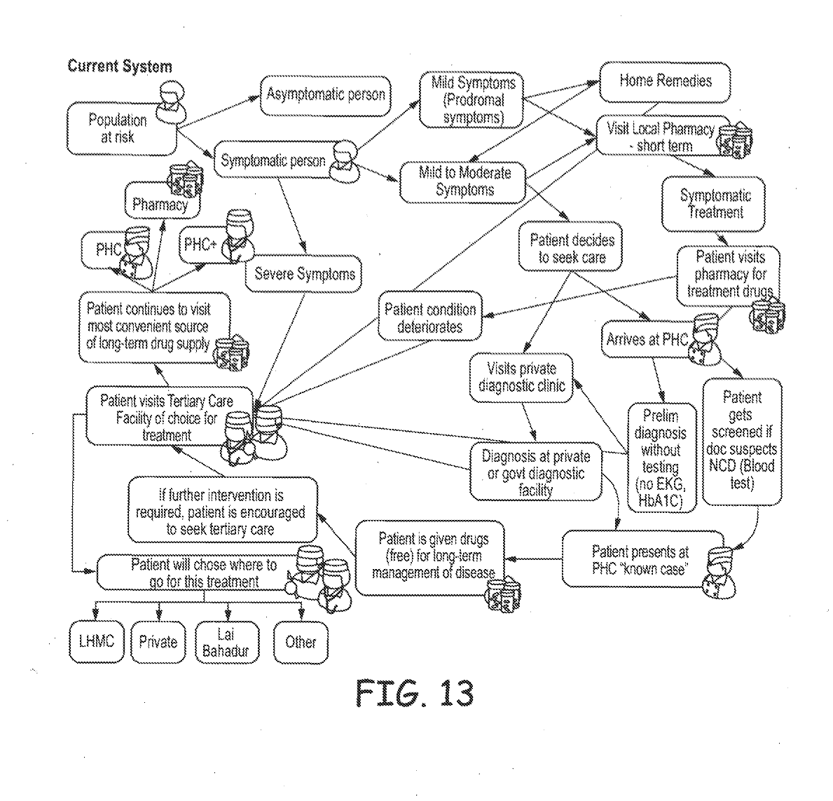

Referring to FIG. 13, following a detailed query process, as is illustrated in the above section; the computer can now make certain conclusions of the current system. A current system will vary depending on the answers received from the user. Similar to the ideal system, it indicates the path a patient takes to receive care for his or her ailment, but in the setting of interest. Most often these scenarios turn out to be complex “spider webs” of possibilities for the patient. A pictoral summary of the path is processed by an algorithm (stored within the Compendium of Algorithms in the Repository). A summary of this care pathway and the various conclusions is then shared with the user. An example of a possible “current scenario” within a context such as a community in Delhi, India is shared below in FIG. 13.

Once this is collected, it presents a comprehensive report of all the information it has gathered summarizing the conclusions from the query process. A brief example would be:

“Yon are a philanthropic organization looking to fund a RHD program in Palam, New Delhi, India, Our records indicate that RHD is highly prevalent in the community you have selected. The current health system is not equipped to provide care for this disease as the first point of care delivery within this community is at the sub center level. These workers who may only have high school diplomas are not trained in delivering care for strep throat which is the first stage of RHD. Over 80 percent of the patient population in this community lives below the poverty line, and there is a very low ratio of healthcare providers to patients. The average patient has to walk almost 3 miles to receive care. This deters early diagnosis and prevention of RHD.

“Some of your other constraints are: the first point of care is too far for patients, there are no diagnostics at the first point of care, the health workers may not be very equipped to provide care, patients have to travel further for a diagnosis, there is no referral from one point of the continuum to the next, there is a high probability of patients being lost to follow up, patients cannot afford services at the primary care level, the tertiary hospital is the next point of referral, these is a secondary hospital in this community but patients are not referred to this location, patient back log at the tertiary setting is high.”

“All of the above conditions deter early diagnosis and prevention of RHD. You are looking to optimize care deliver for RHD in this community and to determine the most cost-effective means to intervene in this disease. Is this accurate?”

If the user responds affirmatively, the algorithm will then proceed to the next step in the process (to determine the optimal path). If not, it will repeat the data-gathering process.

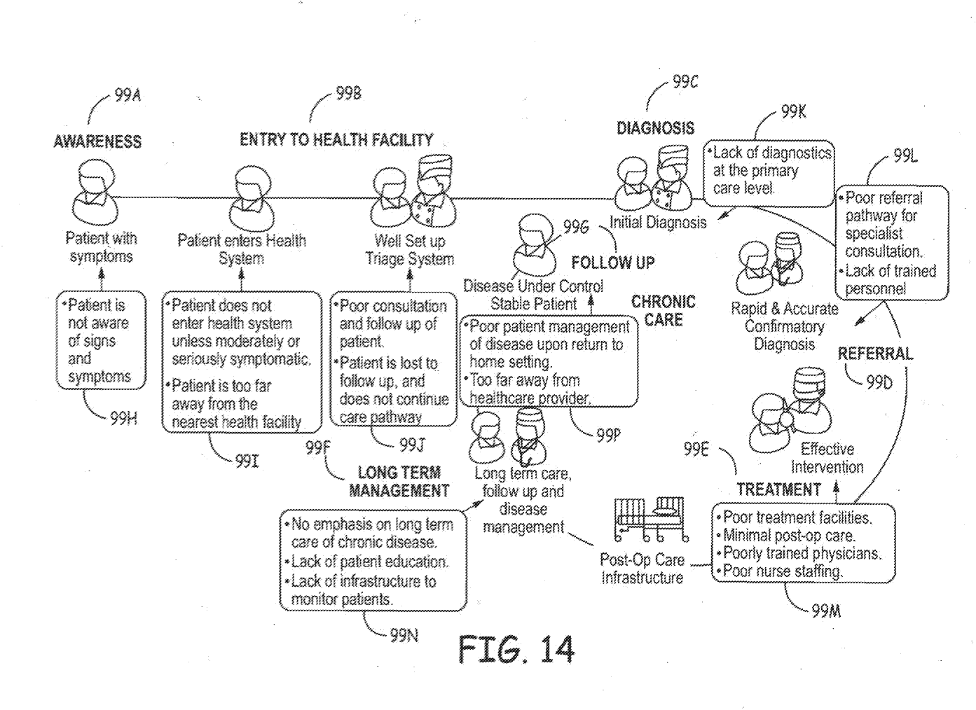

Referring to FIG. 14 if a user confirms that the data presented is accurate, an algorithm is then used to calculate the difference between the ideal and the current system, known as the differential, it does so by superimposing the former over the latter. It then breaks down the care pathway into stages: awareness 99A, entry to health facility 99B, diagnosis 99C, referral 99D treatment 99E, long-term management 99F and follow up 99G. At each stage, the algorithm determines the difference between the ideal system and the current system.

For example, in an ideal system the patient would be less than ten minutes from the nearest health facility. In the current system the patient is more than five hours from the nearest health facility. The differential calculated thus means that the patient is too far from the nearest health facility.

Some of the constraints of the situation 26 in FIG. 1(B) (data gathered from the user, repository (factual database+country fact sheets) and external database), include: funding is limited and no new health care structures or buildings can be built in the next five years in this setting, connectivity to the grid is low in this region and remote care is out of the question, transportation is expensive, and therefore patients cannot afford to use expensive modes of transport and mobile clinics will be cost prohibitive, greater than eighty percent live below the poverty line and therefore cannot afford to travel to a health facility.

Once these differentials 99H, 99I, 99J, 99K, 99L, 99M, 99N, 99P are calculated, the algorithm moves on to attempt to determine the optimal system for that setting by working around the constraints. An optimal system is computed for each stage of the care continuum. In this example, based or the differential and the constraints, an optimal system would have the following suggestions for each stage: At the Awareness Stage—Increased patient awareness about signs and symptoms of disease; At the Entry into health facility stage—Increased patient awareness about healthcare services available, increased number of trained community health workers for frequent outreach to the patients in their community settings, (incentives); At the Diagnosis stage—Point-of-care diagnostics at the primary care setting, health workers trained in use of diagnostics.

At the Referral stage, the optimal system would include increased referral pathways to secondary and tertiary centers, reduced number of patients that are lost to follow up; At the Treatment stage—Increased number of trained health professionals, increased participation of nurses in the care process, improved post-operative care at the tertiary level setting; At the Long term management stage—Patients educated on importance of long term management of illnesses, increased number of burned community health workers to follow upon patients, reduced number of patients that are lost to follow up.

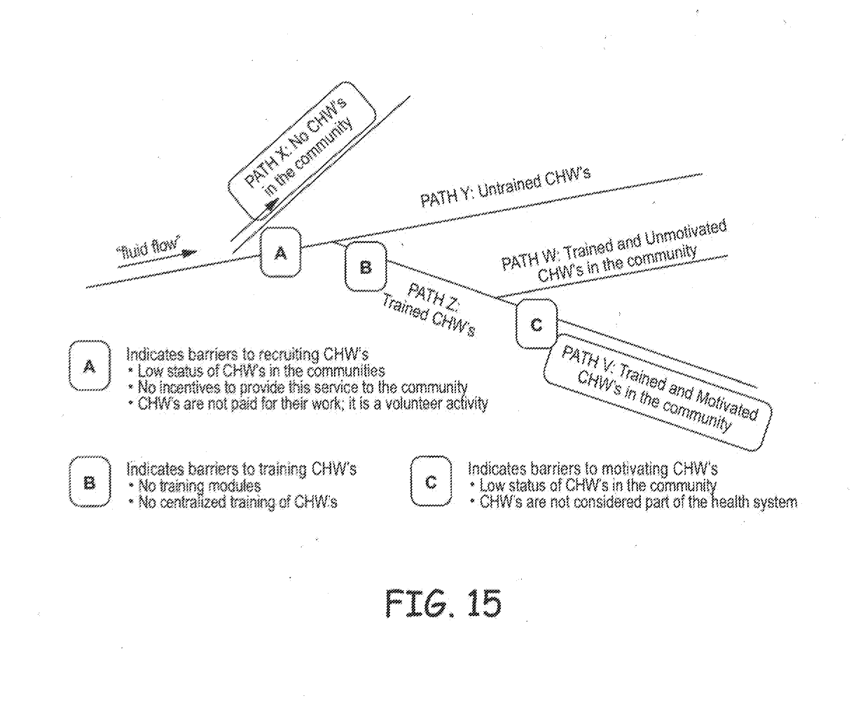

Barriers are then identified using an algorithm that compares the optimal system to the current system to determine what is causing the “block” on the process flow. It uses a “fluid mechanics” analogy to determine the barriers that cause “fluid” to follow the path of least resistance (which is the current system) vs. the optimal system. FIG. 15 shows how barriers are computed. Here, PATH V is the path recommended within the optimal system, PATH X (top box) is the current system. In order to determine how to get from PATH X to PATH V, the algorithm analyzes all the barriers along the way that prevent “flow” from going to PATH V and instead to all other computations between PATH X and PATH Y. Through a process of elimination, it deduces the barriers A, B and C, which prevent PATH V from being achieved.

For example, in one setting the current system might have no community health workers (“CHWs”). In an optimal system there would be an increase number of trained community health workers for frequent outreach to patients in their community settings. The barriers thus computed for this scenario are: CHWs are not paid for their work; it is a volunteer activity. CHWs are not considered part of the health system. There is no incentive to provide this service.

In another example, the patients are frequently lost to follow up. In an optimal system the number of patients lost to follow up would be reduced. Some of the barriers to this are: poor referral pathways, poor patient awareness about long term repercussions of disease, poor patient management on the part of the health facility.

In another example, there is poor disease diagnosis at the primary care level. In an optimal system there would be point-of-care diagnosis at the primary care setting. Some of the barriers to this are: lack of funds for diagnostics acquisition, poor health worker training is using existing diagnostics, patients chose local diagnosis facility over primary care setting.

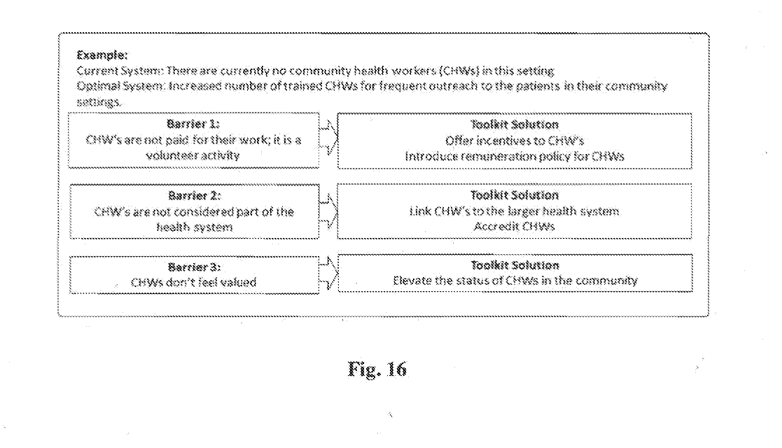

Referring to FIG. 16 for each barrier that is identified, an algorithm is used to search a “Toolkit Database” (within the repository) fur context-specific solutions to remove the respective barrier. After computing the optimal components for each module, it pools all the elements together to provide an “Optimal System” which calls for the following-changes in the current system:

To increase patient awareness about entry into the health system, patients perhaps could be informed about what services are available. There may also be incentive to increase the number of trained community health workers for frequent outreach to patient in their community settings.

To improve early diagnosis, point-of-care diagnosis could be provided at the primary care setting or health workers could be better trained in diagnosis.

To increase patient referral, there could be increase patient referral pathways to secondary and tertiary centers. There would thus be fewer patients lost to follow up.

For better treatment, there could be an increased number of trained health professionals, increased nurse participation in the care process, and improved post-operative care at the tertiary level setting.

For long term management, patients could be educated on long term illness management importance; there could also be an increase in the number of trained community health workers to follow up on patient.

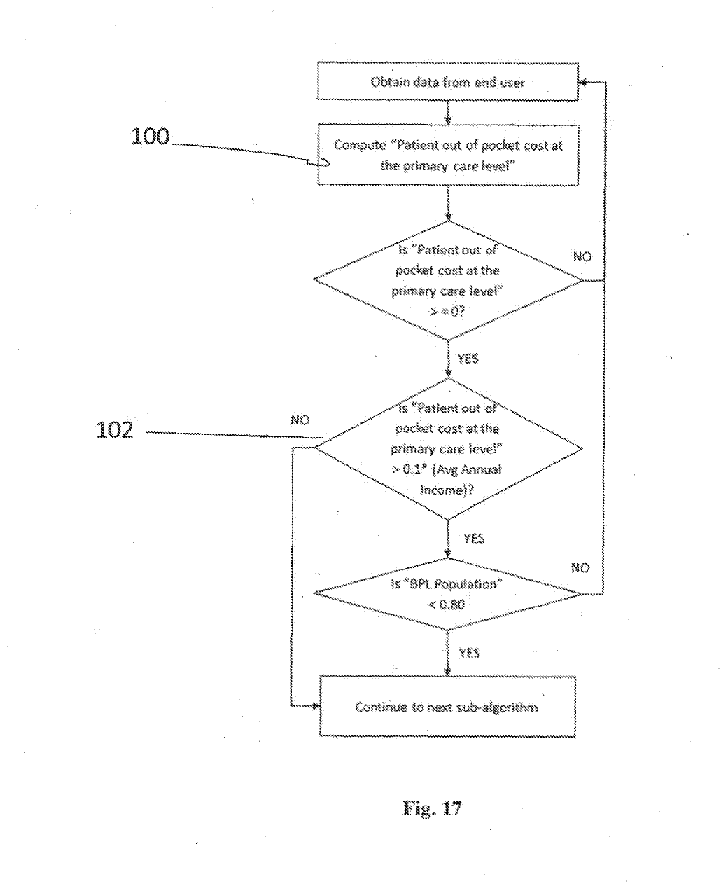

Referring to FIG. 17, as an example of a sub algorithm that performs boundary checks on user input. This is to ensure that user input is accurate and within logical bounds. In this example, the algorithm is trying to find the patient financial capability. The first step is finding what the primary care cost 100 the patient would have to pay. The algorithm then initiates a control loop to find whether this would he feasible given the average annual income 102. If the response is not satisfactory, the loop would not consider this option as a solution.

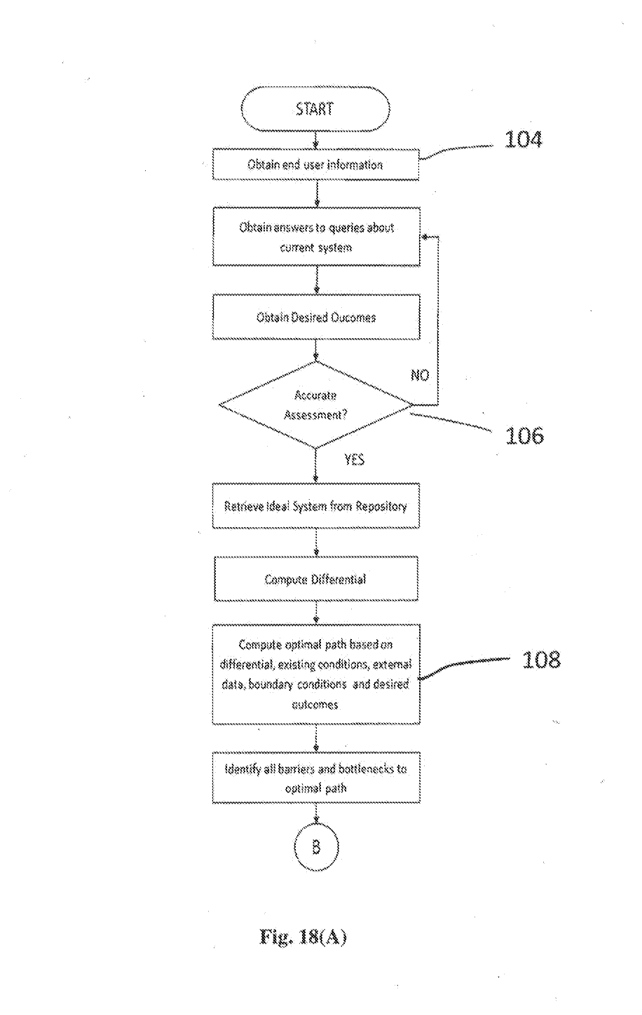

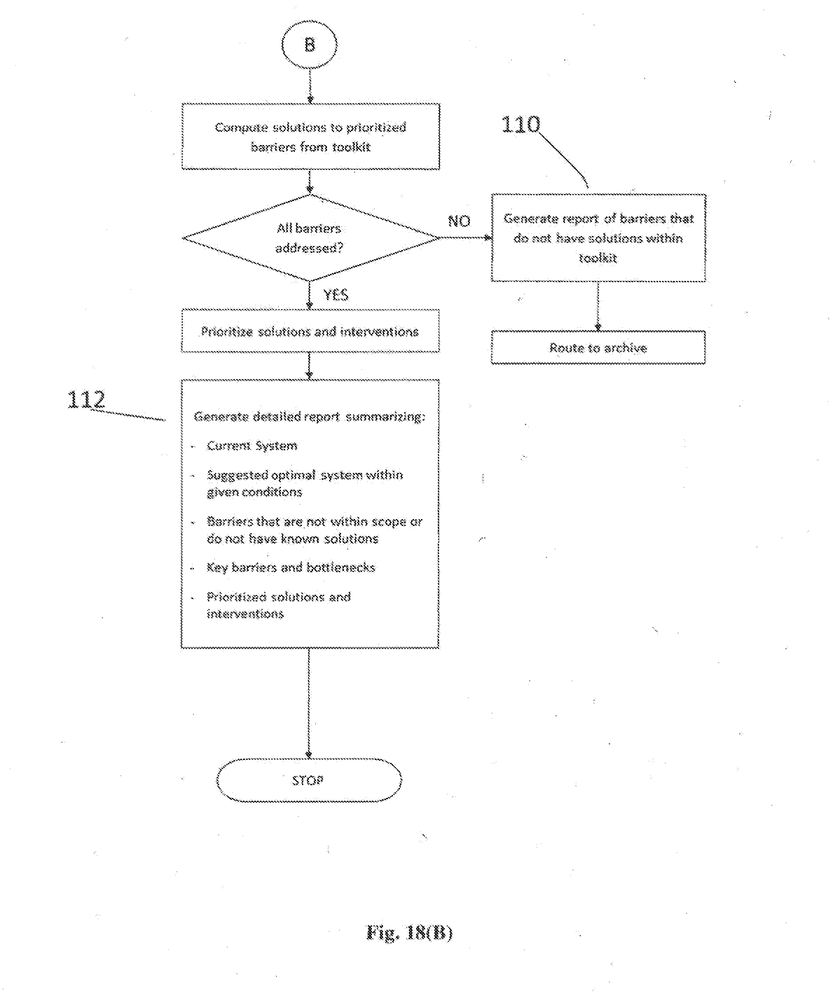

Referring to FIG. 18(A) illustrates a flow diagram summary of the overall process to determine interventions for a system of interest. This entails obtaining information from an end user 104, computing the current system and assessing accuracy of the computation 106, comparing the current system to an ideal system stored within the repository in order to compute the differential. The differential is then factored with the constraints in order to determine the optimal system 108.

Following this, it uses the flow analysis analogy is FIG. 15 to identify barriers in the current system that prevent an optimal system from being achieved. FIG. 18(B) illustrates the continuation with the portfolio of solutions for each possible barrier or gap that has been discovered within a health system. At this stage, the algorithm begins uniting the solutions for the user in a comprehensive report. If the barriers to patient health care are addressed, the algorithm will prioritize the solutions, and create a metric for measuring the progress of the recommended solutions.

The product created by the differential between the ideal system, and the entered information, coupled with the identified barriers, suggested optimal path, and solutions and metrics are compiled into a report 112. This report is the usable product of the algorithm read out.

If not all barriers are addressed, the algorithm will return a list of barriers 110 that are then archived to show what information the system lacks. This may be used later to induce further data gathering.

Subsequently, all the barriers and proposed solutions are presented in a comprehensive manner for the end user to implement. Possible embodiments of the system are given below:

### Scenario 1: Strengthening a Health System

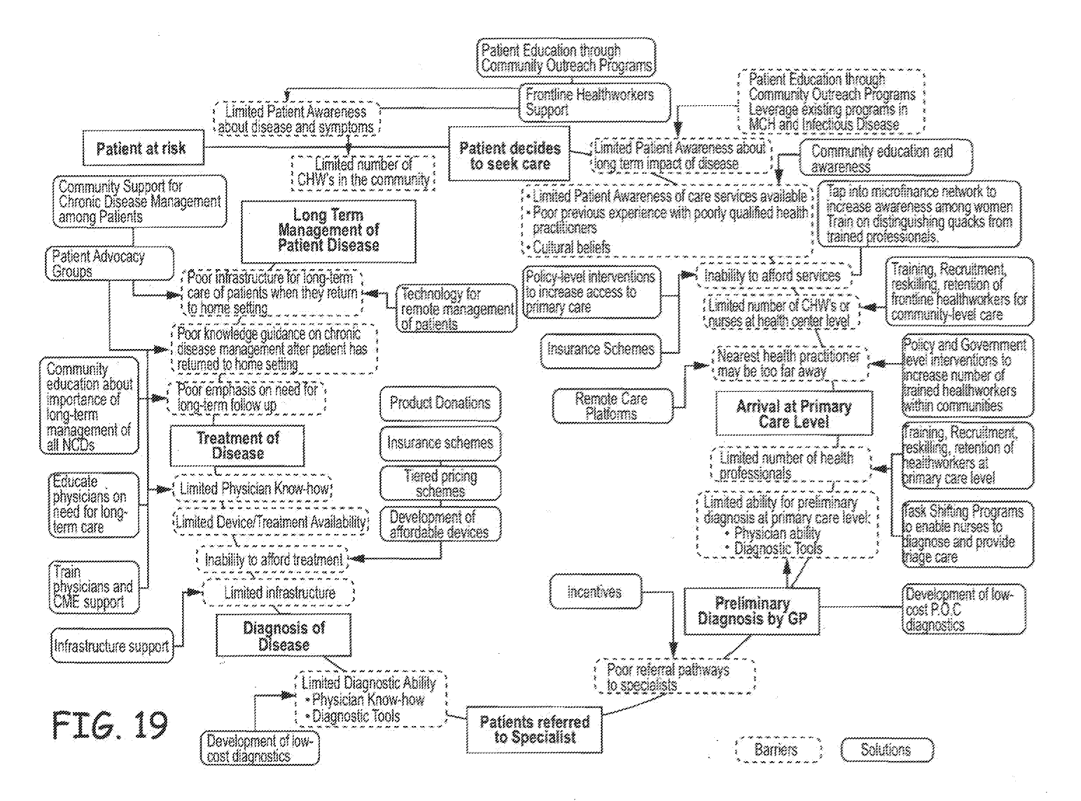

Referring to FIG. 19 is a pictorial representation of the barriers and solutions identified for a recommended optimal path in a given setting related to patient care. This includes a prioritized set of barriers (dotted line boundaries) and solutions. The total information would be included in a final report generated by the algorithm. This illustration also enables brainstorming by other contributors and partners that, could be brought to the table to address a challenge in a multispectral manner.

All this information would be included in a final report generated by the algorithm. For example, if a government sector employee is doing this analysis, they may be interested in teaming which potential partners should be engaged if they are to have a comprehensive continuum of care approach to solving a health system issue.

### Scenario 2: Addressing an Entire Disease Condition

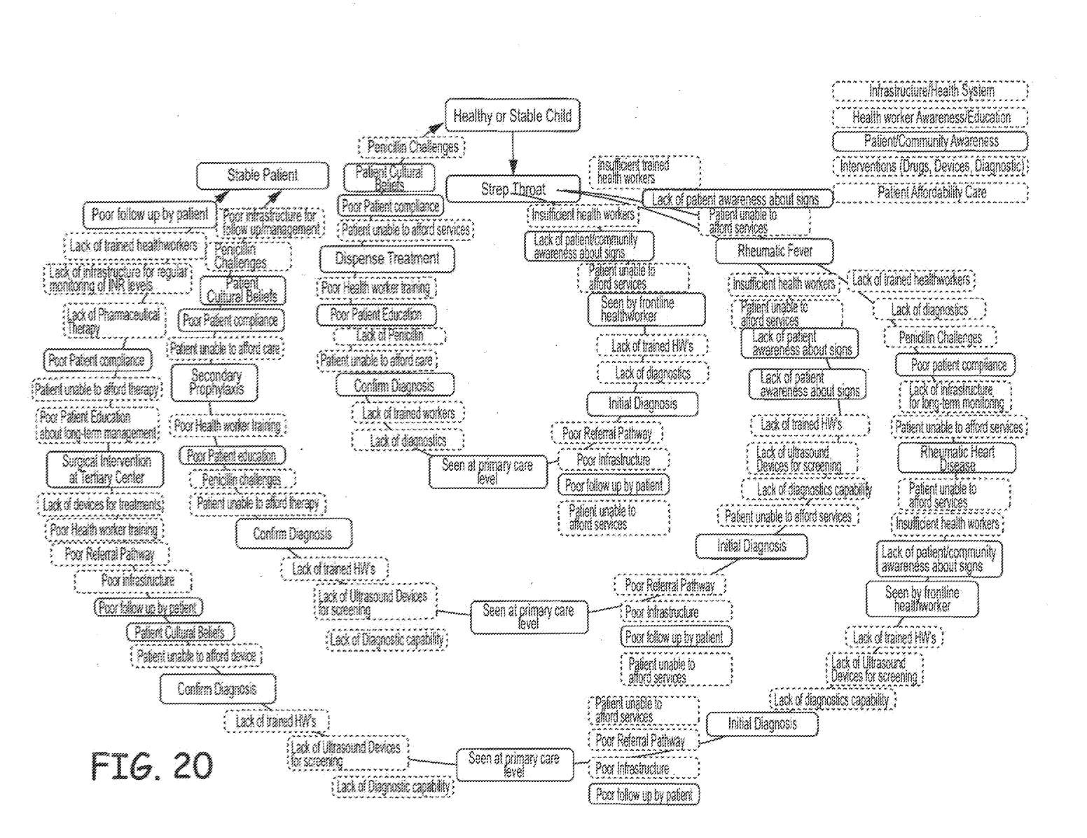

In scenario 2 with reference to FIG. 20, the algorithm is used to identify all the barriers along the disease progression for one disease, rheumatic heart disease (“RHD”). The algorithm has also identified and categorized similar barriers, which recur along the spectrum of the disease: infrastructure, health worker awareness, patient awareness, interventions, and care affordability. This is useful information as Health Ministries or decision makers attempt to determine where to invest funds wisely. The algorithm would further determine solutions for each of these barriers and prioritize them, for the particular setting.

An example of a barrier in this setting would be poor health worker awareness of RHD. For that setting a proposed solution if cell phones are prevalent and online access is possible could be to provide online training modules for the healthcare workers. Another proposed solution in a similar setting where there is no connectivity and where literacy is low could be in-person training of health workers in community setting with pictures and graphics.

The map of FIG. 20 also demonstrate to ministry of Health personnel how primary prevention of this disease is the most cost-effective means to combatting the disease. As the disease progresses, the resources needed to tackle it increase. Therefore, it is deduced that most efforts be focused on primary prevention of Strep Throat among children. This finding could significantly affect the policies and plans within a country or a health system.

The categorization of barriers in this particular map also facilitates easy tracking of the main areas of intervention for this disease: infrastructure, health worker awareness, patient awareness, diagnostics, devices and drugs and affordability of care.

### The Stored Memory or Repository (Random Access Memory of the System)

This repository or database of information is a pre-established, encyclopedic collection of information, pathways and scenarios that cover most health system and health-related topics known within the development world. It is important to highlight that it serves as the crux of this proposed system. By the same token, the extent to and accuracy with which it is populated determines how useful the system and algorithm is. The repository contains several categories of information. Each one is described is more detail below;

Factual Database

Question Bank: Decision-tree of pertinent questions to he asked of the end user in order to obtain information required (to have a “conversation” with the end user)

Boundary conditions and logic cheeks for various settings

Toolkit of solutions for known problems within health system setting

Country Fact Sheets

Compendium of Algorithms

### Factual Database

This information determines the options that are presented to the end user in each multiple-choice question. It is an encyclopedic collection, of facts and information pertaining to countries, economies, health systems and disease conditions. See Section Retrieval of Information from the Repository for more examples of information found in this database.

### Question Bank: Decision-Tree of Pertinent Questions

This is the first step of the interactive portion of the algorithm, and contains critical questions that will help paint the picture of the current scenario. It consists of subcategories, which in turn each have a portfolio of questions. Questions are stored in a decision tree format which branch out with each consecutive response to a question. Please see Section on “Decision Trees” above to see this demonstrated.

Please see the decision-tree for how a query session could unfold.

End user information

What category of the development sector do you belong to?

NGO

Government

Private sector

Academia

Health Institution

Health Professional

Economist

Pubic Health Professional

Policy Individual

Which of the following best describes your overall work?

Planning

Policy

Implementing

Convener

Decision maker

Outside consultant

Do you live in the country or region of interest?

Yes

No

Geographical setting

Coordinates

Please indicate country on map (included)

What is the scope of your intervention in this country?

Whole country

Province

State

City

Community

Village

Panchayat (eg. of context-specific questions—this option would be included if India were chosen as a country on the map)

Development status and socioeconomic information

How would you describe the population that you. will serve

Nomadic

Rural

Urban

Peri-urban?

Out records suggest that Y country has a GDP of US$ 800 million (retrieved from database). This makes it a low-income country (retrieved from database). 75% of its population lives below the poverty line (i.e. BPL=75%) (retrieved from database). How would you describe the population within the setting of choice?

<10% BPL

10-40% BPL

40-70% BPL

70-80% BPL

>80% BPL

How would you describe the primary mode of transport to get to a health facility in this setting?

Walking

Animal

Boat

Public Transport

Scooter

Bicycle

Rickshaw (depends on country choice)

Family Car

Our records show that the average income of patients in this city is $200/month.

Yes

No

If not, please give us a range for average Income of patients

Less than $100 per month.

$100-$400 per month

$400-$800 per month

Greater than $800 per month

Health system context

How many patients are served by the most basic unit of the health system in this setting?

Less than 2000

2000-5,000

Greater than 5,000

Healthcare infrastructure

What is the basic unit of this health system?

Sub center

Primary care center

Community health center

Secondary hospital

Tertiary hospital

How far is the nearest health facility from the average patient by foot?

Less than 2 miles by foot

Between 2 miles and 10 miles

Greater than 10 miles

Category determination

How would you best describe the subject of interest?

A health system-related project

A specific disease focus

Multiple diseases within a global arena

Outbreak

Pandemic

What specific disease area(s) are you interested in?

Cardiac Arrhythmias

Coronary Artery Disease

Diabetes

Rheumatic Heart Disease

Chagas Disease

Guinea Worm

Polio

Gestational Diabetes

Infant mortality

Maternal mortality

HIV/AIDS

Tuberculosis

MDR TB

Diphtheria

Dengue Fever

What stage of the disease are you focused on?

Whole spectrum of disease progression

Only Phase I

Phase I and II

Phase I, II and III

Phase III and above (options given will vary on disease chosen)

How would yon Like to intervene with this disease?

Focus on prevention

Focus on treatment

Focus on long-term management.

Focus on continuum of care

What kind of prevention would you like to focus on?

Primordial

Primary

Secondary

Tertiary

Combinations of above

All

Desired Outcomes

What would you like to achieve as outcomes of this health system level program?

Increase patient access to care

Decrease patient mortality

Enhance patient qualify of life

What would you like to achieve as outcomes of this disease focused intervention in this setting?

Decrease-prevalence of disease

Decrease mortality from disease

Increase patients accessing care for this disease

### Boundary Conditions and Logic Checks

This serves to rule out any goals or criteria suggested by the end user that are not practically or realistically possible given the limitations of the setting.

### EXAMPLE 1

Boundary condition within optimal path calculation:

0>“Distance patient travels by foot”=>2 miles

If data obtained from the end user, and the calculation of the differential between “baseline” and “ideal” leads to confutation of an optimal path that requires a patient in a developing country setting to travel 6 miles by foot to access a primary care center, the system should recognize this as being outside the boundary conditions. For example:

```
  IF “Distance patient travels by foot” <0 OR “Distance patient travels by
  foot” > 2
THEN
  “INVALID”
  REPEAT X (wherein X is the sub-algorithm to compute distance patient
needs to travel by foot)
  ELSE
  CONTINUE
```

### EXAMPLE 2

Boundary condition within optimal path calculation:

```
IF “BPL, population”>.80, THEN
  =<0“Patient out of pocket cost at the primary care level”=< (0.10*AVG
    ANNUAL INCOME)
```

In a setting where greater than 80 percent of the population lives below the poverty line (BPL), the optimal path cannot expect patients to pay more than 10 percent of their annual income on healthcare. In these instances, government intervention is required.

### Country Factsheets

Human Development Index Hating

Economic Indicators (GDP, GNP)

Main means of livelihood by district (agrarian, manufacturing, business, skilled worker)

Gender Distribution by district

Educational level of the household population

Marital status of the household population

Morbidity rates by districts

Housing characteristics by district

Distance from the nearest education facility

Distance from the nearest health facility

Availability of facility and services by district

Literacy rates (men and women) by district within each country

Outcomes of pregnancy by district within each country

While the present invention has been illustrated by the above description of embodiments, and while the embodiments have been described in some detail, it is not the intention of the applicant to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general or inventive concept.

I claim:

1. A computer-implemented method executed by one or more computing devices to assess a specific infrastructure for implementing changes to a local health care system, comprising:
a. identifying a first plurality of elements of an ideal health care system for a predetermined geographic location;
b. identifying a second plurality of elements of a local health care system extant at the geographic location;
c. comparing the first plurality of elements with the second plurality of elements to determine a differential set of elements;
d. modifying the differential set of elements based on corresponding elements from a predetermined set of constraints for the predetermined geographic location to determine a third plurality of elements for a desired health care system implementation;
e. comparing the third plurality of elements for the desired health care system implementation with the second plurality of elements of the local health care system extant at the geographic location to determine barriers and gaps and
f. outputting information indicating infrastructure changes to the second plurality of elements of the local health care system extant at the geographic location to reduce the harriers and the gaps to more closely align the second plurality of elements of the local health care system extant at the geographic location with the third plurality of elements for the desired health care system implementation.

2. A computer implemented method for health care system infrastructure modification, wherein a program stored on a non-transitory computer-readable storage medium instructs one or more processors to perform a method comprising;
a. identifying a first plurality of elements of an ideal health care system for a predetermined geographic location;
b. identifying a second plurality of elements of a local health care system extant at the geographic location;
c. comparing the first plurality of elements with the second plurality of elements to determine a differential set of elements;
d. modifying the differential set of elements based on corresponding elements from a predetermined set of constraints for the predetermined geographic location to determine a third plurality of elements for a desired health care system implementation;
e. comparing the third plurality of elements for the desired health care system implementation with the second plurality of elements of the local health care system extant at the geographic location to determine barriers and gaps and
f. outputting information Indicating infrastructure modifications to the second plurality of elements of the local health care system extant at the geographic location to reduce the barriers and the gaps to more closely align the second plurality of elements of the local health care system extant at the geographic location with the third plurality of elements for the desired health care system implementation.

3. A computer-implemented method executed by one or more computing devices to assess specific infrastructure for implementing changes to a health care system extant at a predetermined geographic location to treat patients, comprising:
a. identifying a first plurality of elements of an ideal health care system for the predetermined-geographic location, the first plurality of elements representing readily available access to known medical and logistic solutions based on predetermined criteria for a plurality of health care indications;
b. providing an input device for interactive input of geography-specific information relating to health symptoms experienced by patients in the predetermined geographic location, the interactive input prompted by a series of questions that depend from answers to previous questions;
c. determining a current treatment capability based on comparison of the interactive input with the first plurality of elements of an ideal health care system;
d. identifying differences between the current treatment capability and the first plurality of elements of art ideal health care system for the geographic location and
e. outputting information indicative of infrastructure changes to change the current care delivery capacity to more closely align with the first plurality of elements of an ideal health care system.

4. A computer implemented method for health care system infrastructure modification, wherein a program stored on a non-transitory computer-readable storage medium instructs one or more processors to perform a method comprising:
a. identifying a first plurality of elements of an ideal health care system for a predetermined geographic location, the first plurality of elements representing readily available access to known medical and logistic solutions based on predetermined criteria for a plurality of health care indications;
b. obtaining interactive input of geography-specific information relating to health symptoms experienced by patients in the predetermined geographic location, the interactive input prompted by a series of questions that depend from answers to previous questions;
c. determining a current care delivery capacity based on comparison of the interactive, input with the first plurality of elements of an ideal health care system;
d. identifying differences between the current treatment capability and the first plurality of elements of an ideal heal the care system for the geographic location;
e. outputting information indicative of infrastructure modifications to change the current treatment capability to more closely align with the first plurality of elements of an ideal health care system.

5. A computer implemented software system for providing solutions to inputted problems comprising:
a. a central processing unit;
b. a stored ready access memory database of information connected to and accessible by the central processing unit;
c. a user interface which receives input from a user being in data connection with said central processing unit,
d. said user interface, capable of receiving data from a user relating to a healthcare system, wherein the user's community or geography form said input from the user;
e. an adaptable database of information that Is external and in data communication with the central processing unit;
f. means for calculating differences between said input and the information in the ready access database;
g. means for recommending an optimal care pathway based on results from calculating the difference between said input and said information; and
h. said central processing unit, said ready access memory, said user interface and said updatable database being in electronic communication with and able to perform, algorithmic functions to operate said means for calculating and said means for recommending to display an output.
